(19) United States
(12) Patent Application Publication
(10) Pub. No.: US 2013/0277308 A1
(43) Pub. Date: Oct. 24, 2013

(54) Water Treatment System and Method for Continuous Forward Osmosis Process Using Osmotically Active Compound with Phase Transition

(71) Applicants: Joon Ha Kim, Gwangju (KR); Sarper Sarp, Gwangju (KR); Ji Jung Lee, Gwangju (KR)

(72) Inventors: Joon Ha Kim, Gwangju (KR); Sarper Sarp, Gwangju (KR); Ji Jung Lee, Gwangju (KR)

(73) Assignee: GWANGJU INSTITUTE OF SCIENCE AND TECHNOLOGY, Gwangiu (KR)

(21) Appl. No.: 13/994,340

(22) PCT Filed: Dec. 16, 2010
(86) PCT No.: PCT/KR10/09021

§ 371 Date: Jun. 14, 2013

(51) Int. Cl. C02F 1/44

(52) U.S. Cl. CPC C02F 1/445
USPC 210/648; 210/188

(57) ABSTRACT

Provided are a water treatment system and method for continuous forward osmosis process using OAC with phase transition, where the OAC with easy phase changes is applied and thereby separation and recovery processes of the draw solution may be performed through continuous processes of a forward osmosis type, and a method thereof. In the water treatment system and method for continuous forward osmosis process using OAC with phase transition according to the exemplary embodiments of the present invention, the OAC with easy phase changes is applied so that separation and recovery processes of the draw solution can be performed through continuous processes of a forward osmosis type, thereby making it possible to produce drinking water. The water treatment process where the OAC with easy phase changes is applied can be used in all water treatment processes of waste water or groundwater, as well as seawater desalination.

### TECHNICAL FIELD

The present invention relates to a water treatment process, and more particularly, to a water treatment system and method for continuous forward osmosis process using osmotically active compound with phase transition.

### BACKGROUND ART

Generally, a series of water treatment processes include removing salinity-containing materials from seawater, which is unable to be used directly as domestic water or industrial water, thus producing drinking water, and domestic water or industrial water with high purity, which are called seawater desalination or seawater deionization. A facility in which fresh water is produced from seawater is called a seawater desalination facility or a seawater desalination plant.

Seawater desalination schemes are largely classified according to fundamental principles. The typical schemes of seawater desalination include an evaporation process that seawater is heated with a heat source and the generated vapor is condensed to obtain fresh water; and a reverse osmosis process that seawater passes through a semi-permeable membrane by using reverse osmosis to produce fresh water.

As for seawater process technologies that have been used since 2000, an evaporation process and a reverse osmosis process occupy 25% and 60%, respectively.

Among them, in a case of a reverse osmosis process, there is a case where production cost is reduced to at least 0.57$/m³, as a result of technological improvement, reduction in membrane unit cost, and the use of energy recovery devices. In addition, this reverse osmosis process has been continuously improved. However, production unit cost cannot be further reduced. The reason why is that, from the viewpoint of economics, the reverse osmosis process has a limitation because electrical energy accounts for ⅓ to ½ of the operational cost.

On the other hand, a forward osmosis process, which has attracted attention as a next generation desalination technology, may considerably decrease energy cost. However, the forward osmosis process has a problem where separation and recovery process technologies of draw solution are not secured, and thus continuous process operation may not be performed. Therefore, it is difficult to be applied to the production of drinking water.

### DISCLOSURE

### Technical Problem

An object of the present invention is to provide a forward osmosis, continuous process, water treatment system, in which an osmotically active substance (i.e., Osmotically Active Compound (OAC)) with easy phase changes is applied and thereby separation and recovery processes of draw solution may be performed by a continuous process of a forward osmosis type, and a method thereof.

Further, the present invention is not limited to the aforementioned objects, and other objects other than the aforementioned objects will be clearly comprehended to those skilled in the art from the following description.

### Technical Solution

In one general aspect, there is provided a water treatment system and method for continuous forward osmosis process using osmotically active compound with phase transition: a draw solution tank in which the osmotically active substance is stored; a first compressor which pressurizes and liquefies the draw solution supplied from the draw solution tank; a second compressor which pressurizes supplying raw water so as to maintain the same pressure as the draw solution pressurized through the first compressor; a membrane module where the draw solution liquefied through the first compressor and the supplying raw water pressurized through the second compressor are flowed into a first channel and a second channel, in which they are separated by an internal membrane, in which a forward osmosis process is performed where a water component of the supplying raw water is permeated into the first channel through the membrane from the second channel and thus the draw solution is diluted; a first expansion valve which removes the pressure of the draw solution that has been diluted through the membrane module and vaporizes the draw solution; and a first phase separation unit which separates liquid phase produced water from the draw solution that has been vaporized through the first expansion valve.

Furthermore, the vaporized draw solution in the first phase separation unit may be recovered into the draw solution tank through a first recovery pipe.

Furthermore, in the membrane module, the draw solution may be diffused reversely to the water-permeation reverse direction through the membrane, and a small amount of the draw solution may be lost.

Furthermore, the water treatment system for continuous forward osmosis process using OAC with phase transition may further include a second expansion valve where the pressure of the draw solution that has been diffused reversely through the membrane module is removed and the draw solution in concentrated water that has been discharged from the membrane module is vaporized.

Furthermore, the water treatment system for continuous forward osmosis process using OAC with phase transition may further include a second phase separation unit where the draw solution that has been vaporized through the second expansion valve is separated from the concentrated water.

Furthermore, the draw solution separated through the second phase separation unit may be recovered into the draw solution tank through a second recovery pipe.

In another general aspect, there is provided a water treatment method for continuous forward osmosis process using osmotically active compound (OAC) with phase transition including: (a) pressurizing and liquefying draw solution supplied from a draw solution tank by a first compressor; (b) pressurizing supplying raw water by a second compressor so as to maintain the same pressure as the draw solution pressurized through the first compressor; (c) flowing the draw solution liquefied through the first compressor and the supplying raw water pressurized through the second compressor into a first channel and a second channel, in which they are separated by an internal membrane in a membrane module; (d) performing a forward osmosis process where a water component of the supplying raw water is permeated into the first channel through the membrane from the second channel and the draw solution is diluted; (e) removing the pressure of the draw solution that has been diluted through the membrane module and vaporizing the draw solution by a first expansion valve; and (f) separating liquid phase produced water from the draw solution that has been vaporized through the first expansion valve by a first phase separation unit.

Furthermore, the water treatment method for continuous forward osmosis process using OAC with phase transition may further include (g) recovering, into the draw solution tank, the vaporized draw solution in the first phase separation unit through a first recovery pipe.

Furthermore, the water treatment method for continuous forward osmosis process using OAC with phase transition may further include (h) removing the pressure of the draw solution that has been diffused reversely to the water-permeation direction through the membrane module and vaporizing the draw solution in concentrated water that has been discharged from the membrane module, by a second expansion valve.

Furthermore, the water treatment method for continuous forward osmosis process using OAC with phase transition may further include (i) separating the draw solution that has been vaporized through the second expansion valve from the concentrated water by a second phase separation unit.

Furthermore, the water treatment method for continuous forward osmosis process using OAC with phase transition may further include (j) recovering, into the draw solution tank, the draw solution that has been separated by the second phase separation unit through a second recovery pipe.

Other embodiments of the details may be included in the detailed description and drawings.

### Advantageous Effects

According to the present invention configured as described above, the OAC with easy phase changes is applied and thus separation and recovery processes of the draw solution may be performed through the continuous processes of a forward osmosis type, which can be used as a drinking water producing technology.

Furthermore, the forward-osmosis, continuous-process, water-treatment method of the present invention is considered as a next generation technology. Also, this process can be substituted for existing reverse osmosis seawater desalination technologies which still require consumption of a lot of energy because a high pressure pump is used in order to obtain produced water.

Furthermore, the forward-osmosis, continuous-process, water-treatment method can be applied as a hybrid process in reuse fields of water. Thus, produced water with high quality can be expected using high potential water reuse membrane process.

Furthermore, low energy type drinking water producing technology can be secured by using a forward-osmosis, continuous-process system (about <0.5 kWh/m³). Also, the forward-osmosis technology which is evaluated as low energy green technologies can be commercially used.

The effects of the present invention are not limited to the aforementioned effects, and other effects other than the aforementioned effects will be clearly comprehended to those skilled in the art from the description of the claims.

### DESCRIPTION OF DRAWINGS

FIG. 1 is a schematic configuration diagram of a water treatment system for continuous forward osmosis process using osmotically active compound (OAC) with phase transition according to an exemplary embodiment of the invention; and

FIG. 2 is a flow chart for describing the water treatment method for continuous forward osmosis process using OAC with phase transition according to an exemplary embodiment of the invention.

### BEST MODE

Advantages and features of the present invention and configurations and methods to achieve them will be elucidated with reference to exemplary embodiments described below in detail along with the accompanying drawings. However, the present invention is not limited by disclosed exemplary embodiments below, but can be realized by a variety of types. Only the present embodiments are provided such that the present invention is completely disclosed. Also the present embodiments are provided to completely explain categories of the present invention to those skilled in the art in the technical field of the present invention. Therefore, the present invention is only defined by the scopes of claims. Further, for reference, when it is determined that the detailed description of the known functions or configurations related to the present invention may obscure the gist of the present invention, the detailed description thereof will not be repeatedly described.

Prior to the description, it is noted in advance that the water treatment process described below exemplifies a seawater desalination process as an example, but may include all water-treatment processes of ground water or waste water processes to be treated as well as a seawater desalination process.

Referring to the accompanying drawings, the water treatment system and method for continuous forward osmosis process using osmotically active compound (OAC) with phase transition according to an exemplary embodiment of the invention will be described below.

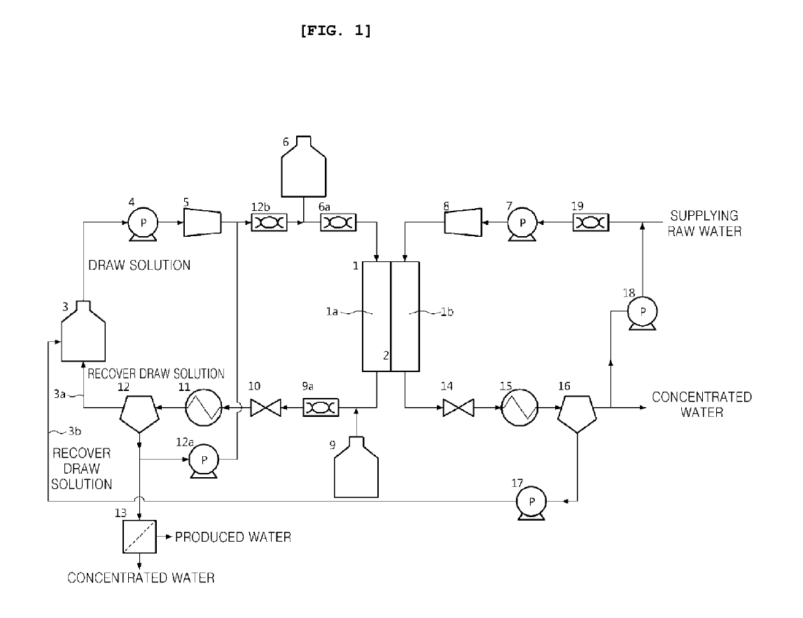

FIG. 1 is a schematic configuration diagram of a water treatment system for continuous forward osmosis process using OAC with phase transition according to an exemplary embodiment of the invention.

As shown in FIG. 1, the water treatment system for continuous forward osmosis process using OAC with phase transition according to an exemplary embodiment of the invention includes a draw solution tank 3, a first compressor 5, a second compressor 8, a membrane module 1, a first expansion valve 10, a second expansion valve 14, a first phase separation unit 12, a second phase separation unit 16, and the like.

In the draw solution tank 3, an osmotically active substance (OAC) is stored, which is suitable for forward osmosis, continuous process using phase changes.

Herein, the draw solutions suitable for the present invention should have the following properties:

1. The osmotically active substance (OAC) in the draw solution should have a low boiling point, which may be in a range of 10 to 30° C.

2. The OAC should be completely dissolved into an aqueous solution.

3. The OAC should have a low molecular weight, which may be in a range of 30 to 150 g/mol.

4. The osmotically draw solution should have a low vapor pressure at a normal temperature (20 to 25° C.), which may be in a range of 400 to 3000 mmHg.

In other words, the compounds, which may satisfy properties described above in the present invention, are used as osmotically active substances. The osmotically active substances may be selected from compounds such as acetaldehyde, methylamine, dimethylamine, trimethylamine, and others, but is not limited thereto.

The OAC is present in a gas state in the draw solution tank 3, which should be kept airtight in order to prevent loss of the OAC.

The first compressor 5 pressurizes and liquefies the draw solution supplied from the draw solution tank 3. In other words, the first compressor 5 serves to pressurize the draw solution, OAC, in a gas state supplied from the draw solution tank 3 and to thereby change the state of the OAC into a liquid state.

Herein, a low pressure pump 4 is provided at an inlet of the first compressor 5, specifically between the draw solution tank 3 and the first compressor 5. Also, the OAC is supplied continuously to the first compressor 5 with the low pressure pump 4 in order to completely liquefy the OAC.

Furthermore, a mixer 12b is provided at the outlet of the first compressor 5. The mixer 12b serves to blend, at a certain ratio, the liquefied OAC with water that has been transferred from the first phase separation unit 12 described below, in order to control the osmosis pressure of the draw solution.

Furthermore, when pH is decreased, it helps ionization of the OAC. Therefore, base may be supplied from a base tank 6 and blended with a mixer 6a before the membrane module 1. Herein, the base may use sodium hydroxide (NaOH), and is not limited thereto.

The second compressor 8 is disposed at supplying raw water (for example, seawater), and serves to pressurize the supplying raw water so as to maintain the same pressure as the draw solution pressurized through the first compressor 5.

Herein, a low pressure pump 7 is provided at the inlet of the second compressor 8, and supplying raw water is supplied continuously to the second compressor 8 with the low pump 7, such that the supplying raw water has the same pressure as the draw solution. As a result, the pressurized draw solution may result in offsetting the effect of pressure applied during a membrane separation process.

The membrane module 1 is a membrane module where the draw solution that has been liquefied through the first compressor 5 and the supplying raw water that has been pressurized through the second compressor 8 are flowed into a first channel 1a and a second channel 1b, respectively, in which they are separated by an internal membrane 2. Herein, a forward osmosis process is performed where a water component of the supplying raw water is permeated into the first channel 1a through a membrane 2 from the second channel 1b and thus the draw solution is diluted.

Herein, the forward osmosis (FO) is a process such that the high concentration draw solution and the seawater are brought into contact with each other through the membrane (semi-permeable membrane) 2 therebetween, in which fresh water in the seawater is absorbed into the draw solution, and then the fresh water is separated from the draw solution. At this time, only fresh water in seawater is permeated into the high concentration solution by osmosis of the membrane using the draw solution. Then, the draw solution in the diluted draw solution is separated/concentrated, and then reused to produce fresh water, which is called a forward osmosis seawater desalination. The forward osmosis seawater desalination process may be comprehended by known technologies, and therefore description thereof will not be repeatedly described.

The membrane 2 is a semi-permeable membrane, and may use a forward membrane in the present embodiment, but is not limited thereto. The membrane may be selected from a forward osmosis membrane, a reverse osmosis (RO) membrane, and a nanofiltration membrane.

In the membrane module 1, the draw solution is diffused reversely to the water-permeation reverse direction through the membrane 2, and thus a small amount of draw solution may be lost.

In addition, after the membrane module 1, acid is injected into the diluted draw solution from an acid tank 9, in order to adjust a pH of the draw solution, and then blended with a mixer 9a. Herein, the acid may be hydrochloric acid (HCl), but is not limited thereto.

The first expansion valve 10 serves to remove the pressure of the draw solution that has been diluted through the membrane module 1, to thereby partially or completely vaporize the OAC in the draw solution.

Additionally, a heating device 11, for example a heater is provided at the outlet of the first expansion valve 10. The heating device 11 may be used arbitrarily as long as the draw solution has a boiling point higher than an atmosphere temperature.

The first phase separation unit 12 separates liquid phase produced water (for example, drinking water) from the draw solution that has been vaporized through the first expansion valve 10. In other words, the first phase separation unit 12 separates the liquid phase produced water from the vaporized OAC by a vapor-liquid separation.

A first recovery pipe 3a is provided so as to connect between the first phase separation unit 12 and the draw solution tank 3. The vaporized draw solution OAC is transferred and then recovered to the draw solution tank 3 through the first recovery pipe 3a from the first phase separation unit 12.

In addition, a low pressure pump 12a is provided at the outlet of the first phase separation unit 12. The low pressure pump 12a continuously supplies the produced water to a mixer 12b at a certain ratio, which is blended with the liquefied OAC.

In addition, since salts of anions and cations which are injected to the draw solution during a pH adjustment process are present in produced drinking water, additionally, a low pressure membrane module (if possible, nanofiltration may be used, but is not limited) 13 may separate salts of anions and cations from the produced water.

The second expansion valve 14 serves to remove the pressure of the draw solution that has been diffused reversely through the membrane module 1, and to vaporize the draw solution in concentrated water that has been discharged from the membrane module 1.

More specifically, the OAC is diffused into the supplying raw water which is present in the reverse direction to the water-permeation direction through the membrane 2. In this case, when the pressure is removed with the second expansion valve 14, a small amount of the OAC in the concentrated water that has been diffused reversely in the water-permeation direction is partially or completely vaporized.

Additionally, a heating device 15, for example, a heater is provided at the outlet of the second expansion valve 14. The heating device 15 may heat the concentrated water as long as the draw solution may have a boiling point higher than an atmosphere temperature.

The second phase separation unit 16 separates a small amount of the OAC in the concentrated water from the concentrated water.

A second recovery pipe 3b is provided so as to connect between the second phase separation unit 16 and the draw solution tank 3, and a draw solution recovery pump 17 is provided on the second recovery pipe 3b, such that the draw solution OAC separated by the second phase separation unit 16 is recovered and recycled to the draw solution tank 3 through the second recovery pipe 3b by driving the draw solution recovery pump 17.

The concentrated water through the second phase separation unit 16 is blended with the supplying raw water or is discharged out of the system. At this time, a low pressure pump 18 is provided on a pipe which is connected to the supplying raw water from the second phase separation unit 16. The low pressure pump 18 continuously supplies a portion of the concentrated water to a supplying unit of the supplying raw water. Then, the supplying raw water is blended with the concentrated water, thus resulting in improving a recovery rate of the produced drinking water.

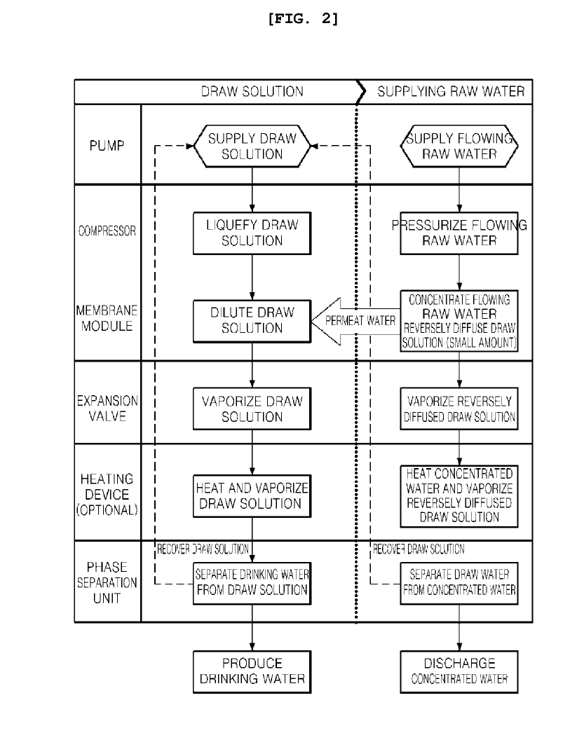

FIG. 2 is a flow chart for describing the continuous-process, water-treatment method using phase changes of the draw solution according to an exemplary embodiment of the invention.

As shown in FIG. 2, the draw solution is stored in the draw solution tank 3 in a gas state at a normal temperature and is continuously supplied to the first compressor 5 by driving the low pressure pump 4. The supplying raw water (for example, seawater) is supplied continuously to the second compressor 8 by driving the low pressure pump 7.

The first compressor 5 pressurizes and liquefies the draw solution supplied from the draw solution tank 3, and the second compressor 8 pressurizes the supplying raw water so as to maintain the same pressure as the draw solution pressurized through the first compressor 5.

The mixer 12b provided at the outlet of the first compressor 5 blends the liquefied OAC, at a certain ratio, with water transferred from the first phase separation unit 12, in order to control an osmosis pressure of the draw solution.

The draw solution liquefied through the first compressor 5 is flowed into the first channel 1a of the membrane module 1 and the supplying raw water pressurized through the second compressor 8 is flowed into the second channel 1b of the membrane module 1, such that the draw solution and the supplying raw water are brought into contact with each other in a boundary of the membrane 2.

A forward osmosis process is carried out in which a water component of the supplying raw water is permeated to the first channel 1a through the membrane 2 from the second channel 1b and is diluted. Additionally, as the water component of the supplying raw water permeates from the second channel 1b to the first channel 1a, the supplying raw water is concentrated in the second channel 1b, and a small amount of the draw solution is diffused reversely to the water-permeation direction through the membrane module 1.

The first expansion valve 10 serves to remove the pressure of the draw solution that has been diluted through the membrane module 1, and to partially or completely vaporize the draw solution, OAC. Further, the second expansion valve 14 removes the pressure of the draw solution that has been diffused reversely to the water-permeation direction through the membrane module 1, and thus serves to vaporize the draw solution in concentrated water that has been discharged from the membrane module 1.

At this time, the draw solution is heated and completely vaporized by the heating device 11 provided at the outlet of the first expansion valve 10. Furthermore, the concentrated water and the reverse direction-diffused draw solution are heated and completely vaporized by a heating device provided at the outlet of the second expansion valve 14.

The first phase separation unit 12 separates the liquid phase produced water from the draw solution that has been vaporized through the first expansion valve 10 and the heating device 11. In other words, the first phase separation unit 12 separates the liquid phase produced water from the vaporized OAC by a vapor-liquid separation. The vaporized draw solution in the first phase separation unit 12 is recovered to the draw solution tank 3 through the first recovery pipe 3a, and recycled.

The second phase separation unit 16 separates the draw solution from the concentrated water through the expansion valve 14 and the heating valve 15. The draw solution OAC separated by the second phase separation unit 16 is recovered to the draw solution tank 3 through the second recovery pipe 3b by driving the draw solution recovery pump 17, and recycled.

According to the present invention, the OAC with easy phase changes is applied and thereby separation and recovery processes of the draw solution may be performed through a continuous process of a forward osmosis type, which can be used as a drinking water producing technology. Furthermore, the forward-osmosis, continuous-process, water-treatment method of the present invention is considered as the next generation technology. This method can be substituted for existing reverse osmosis seawater desalination technologies which still requires consumption of a lot energy because a high pressure pump is used in order to obtain produced water (for example, drinking water).

Exemplary embodiments of the present invention was described referring to the accompanying drawings described above, but it could be found that those skilled in the art in technical field of the invention performs other specific exemplary embodiments without changing necessary features or technical scope of the invention. Therefore, it should be understood that the above-mentioned embodiments are not restrictive but are exemplary in all aspects. It should be interpreted that the scope of the present invention is defined by the following claims rather than the above-mentioned detailed description and all modifications or alterations deduced from the meaning, the scope, and equivalences of the claims are included in the scope of the present invention.

### INDUSTRIAL AVAILABILITY

The present invention proposes a water treatment system and method for continuous forward osmosis process using OAC with phase transition where the OAC with easy phase changes is applied and thereby separation and recovery processes of the draw solution may be performed through a continuous process of a forward osmosis type, and a method thereof. The water treatment process where the OAC with easy phase changes is applied can be used in all water treatment processes of waste water or groundwater, as well as seawater desalination.

1. A water treatment system for continuous forward osmosis process using osmotically active compound (OAC) with phase transition, the system comprising:
a draw solution tank in which draw solution containing the osmotically active substance is stored;
a first compressor which pressurizes and liquefies the draw solution supplied from the draw solution tank;
a second compressor which pressurizes supplying raw water so as to maintain the same pressure as the draw solution pressurized through the first compressor;
a membrane module where the draw solution liquefied through the first compressor and the supplying raw water pressurized through the second compressor are flowed into a first channel and a second channel, respectively, so that the draw solution and supplying raw water are separated from each other by an internal membrane, wherein a forward osmosis process is performed where a water component of the supplying raw water is permeated into the first channel through the membrane from the second channel and thus the draw solution is diluted;
a first expansion valve which removes the pressure of the draw solution that has been diluted through the membrane module and vaporizes the draw solution; and
a first phase separation unit which separates liquid phase produced water from the draw solution that has been vaporized through the first expansion valve.

2. The water treatment system for continuous forward osmosis process using osmotically active compound (OAC) with phase transition of claim 1, wherein the vaporized draw solution in the first phase separation unit is recovered into the draw solution tank through a first recovery pipe.

3. The water treatment system for continuous forward osmosis process using osmotically active compound (OAC) with phase transition of claim 1, wherein, in the membrane module, the draw solution is diffused reversely to the water-permeation reverse direction through the membrane, and a small amount of the draw solution is lost.

4. The water treatment system for continuous forward osmosis process using osmotically active compound (OAC) with phase transition of claim 3, further comprising: a second expansion valve where the pressure of the draw solution that has been diffused reversely through the membrane module is removed and the draw solution in concentrated water that has been discharged from the membrane module is vaporized.

5. The water treatment system for continuous forward osmosis process using osmotically active compound (OAC) with phase transition claim 4, further comprising: a second phase separation unit where the draw solution that has been vaporized through the second expansion valve is separated from the concentrated water.

6. The water treatment system for continuous forward osmosis process using osmotically active compound (OAC) with phase transition of claim 5, wherein the draw solution separated through the second phase separation unit is recovered into the draw solution tank through a second recovery pipe.

7. A water treatment method for continuous forward osmosis process using osmotically active compound (OAC) with phase transition, the method comprising:
(a) pressurizing and liquefying draw solution supplied from a draw solution tank by a first compressor;
(b) pressurizing supplying raw water by a second compressor so as to maintain the same pressure as the draw solution pressurized through the first compressor;
(c) flowing the draw solution liquefied through the first compressor and the supplying raw water pressurized through the second compressor into a first channel and a second channel, in which the draw solution and the supplying raw water are separated from each other by an internal membrane in a membrane module;
(d) performing a forward osmosis process where a water component of the supplying raw water is permeated into the first channel through the membrane from the second channel and the draw solution is diluted;
(e) removing the pressure of the draw solution that has been diluted through the membrane module and vaporizing the draw solution by a first expansion valve; and
(f) separating liquid phase produced water from the draw solution that has been vaporized through the first expansion valve by a first phase separation unit.

8. The water treatment method for continuous forward osmosis process using osmotically active compound (OAC) with phase transition of claim 7, further comprising: (g) recovering, into the draw solution tank, the vaporized draw solution in the first phase separation unit through a first recovery pipe.

9. The water treatment method for continuous forward osmosis process using osmotically active compound (OAC) with phase transition of claim 8, further comprising: (h) removing the pressure of the draw solution that has been diffused reversely to the water-permeation direction through the membrane module and vaporizing the draw solution in concentrated water that has been discharged from the membrane module, by a second expansion valve.

10. The water treatment method for continuous forward osmosis process using osmotically active compound (OAC) with phase transition of claim 9, further comprising: (i) separating the draw solution that has been vaporized through the second expansion valve from the concentrated water by a second phase separation unit.

11. The water treatment method for continuous forward osmosis process using osmotically active compound (OAC) with phase transition of claim 10, further comprising: (j) recovering, into the draw solution tank, the draw solution that has been separated by the second phase separation unit through a second recovery pipe.
